(19) United States
(12) Patent Application Publication
(10) Pub. No.: US 2012/0008986 A1
(43) Pub. Date: Jan. 12, 2012

(54) IMAGE FORMING APPARATUS

(75) Inventor: Hajime KAJI, Abiko-shi (JP)

(73) Assignee: CANON KABUSHIKI KAISHA, Tokyo (JP)

(21) Appl. No.: 13/176,831

(22) Filed: Jul. 6, 2011

(30) Foreign Application Priority Data
Jul. 7, 2010 (JP) 2010-154642

(51) Int. Cl. G03G 15/00

(52) U.S. Cl. 399/167

(57) ABSTRACT

An image forming apparatus that enables a high-quality color image having less image deterioration can be formed. First and second developing units develop an electrostatic latent image formed on each of first and second rotating members. First and second drive units drive the respective first and second rotating members. A control unit controls the first and second drive units in order that a phase of the first rotating member and a phase of the second rotating member have a predetermined relationship therebetween after the completion of an image formation, performs a stop process for stopping the first and second drive units, and further varies a period from the completion of controlling the drives of the first and second drive units to the execution of the stop process.

### BACKGROUND OF THE INVENTION

1. Field of the Invention

The present invention relates to an image forming apparatus that forms a color image by a photosensitive drum rotationally driven.

2. Description of the Related Art

A mainstream of an electrophotographic image forming apparatus (for example, a copier, a printer and a facsimile apparatus) has rapidly been shifted to a color image forming apparatus from a monochromatic image forming apparatus in recent years. A tandem type has been known as one of electrophotographic systems in the color image forming apparatus.

The tandem type includes a system in which a one-colored toner image is formed on each of plural image bearing members, which are arranged side by side, and the respective one-colored toner images are sequentially transferred onto a recording medium so as to form and record a color image. Since the tandem-type image forming apparatus can independently form the image in each color, the apparatus can advantageously attain an image forming speed equal to that of the monochromatic image forming apparatus, while performing image formation during one passage.

On the other hand, in the tandem-type color image forming apparatus, the misalignment of the respective image forming positions of the respective colors causes color misregistration in the formed image, since plural image bearing members are arranged side by side, thereby resulting in that the deterioration in image quality may occur. Typical examples of the color misregistration include a periodical color misregistration caused by a vibration of a shaft of a rotating member such as an image bearing member, uneven rotation of the rotating member and uneven speed of a transfer belt.

As a countermeasure for preventing the generation of the periodic color misregistration, there have been discussed various methods including a method of individually controlling a rotation phase of the rotating member of each color. Specifically, there has been discussed an image forming apparatus described below. In this image forming apparatus, a first image bearing member group on which a color image is formed and a second image bearing member on which a black image is formed are driven under different drive controls, wherein phases of the respective drive variation periods are synchronized (e.g., see USP6173141).

In the technique disclosed in USP6173141, timing of the maximum rotation speed in the variation period of the rotation speed of the photosensitive drum group (first image bearing member group) for forming a color image and that for the photosensitive drum (second image bearing member) for forming a black image are synchronized.

In the color image forming apparatus performing the phase control as described above, each motor for rotating each of the plural photosensitive drums is slowly started, and the phase control is not performed upon starting the motor, but performed upon stopping the motor, whereby an increase in a first printing time can be prevented.

However, if the phase control is performed only when each motor is stopped, positions where the respective motors are stopped are always substantially equal to one another, since the period from when the phase control is started upon detecting the phase difference to when the respective motors are stopped is substantially the same for each motor. Therefore, when the same images (format) are formed again and again in the color image forming apparatus performing the control described above, in each of the photosensitive drum, the same portion thereon is used again and again. Accordingly, a residual-image phenomenon, which is referred to as “drum memory”, and which corresponds to a phenomenon that an electrostatic image remains on the photosensitive drum, is caused, thereby entailing deterioration in image quality.

### SUMMARY OF THE INVENTION

Accordingly, the present invention provides an image forming apparatus comprising first and second rotating members, first and second exposure units that form an electrostatic latent image on each of the first and second rotating members, first and second developing units that develop the electrostatic latent image formed on each of the first and second rotating members, first and second drive units that drive the respective first and second rotating members, and a control unit that controls, after the completion of an image formation, the first and second drive units in order that a phase of the first rotating member and a phase of the second rotating member have a predetermined relationship therebetween, and performs a stop process for stopping the first and second drive units, wherein the control unit varies a period from the completion of controlling the drives of the first and second drive units to the execution of the stop process.

The features and advantages of the invention will become more apparent from the following detailed description taken in conjunction with the accompanying drawings.

### BRIEF DESCRIPTION OF THE DRAWINGS

FIG. 1 is a view showing schematically a configuration of an image forming apparatus according to an exemplary embodiment;

FIG. 2 is a block diagram showing schematically a configuration of a control system of the image forming apparatus according to the exemplary embodiment;

FIG. 3 is a view showing a configuration of a drive system for a photosensitive drum arranged in the image forming apparatus according to the exemplary embodiment;

FIGS. 4A and 4B are graphs showing respectively a phase synchronization in a rotation speed of the photosensitive drum according to the exemplary embodiment;

FIG. 5 is a timing chart from the phase control to the stop control of the photosensitive drum arranged in the image forming apparatus according to the exemplary embodiment; and

FIG. 6 is a flowchart of the phase control and the stop control of the photosensitive drum arranged in the image forming apparatus according to the exemplary embodiment.

### DESCRIPTION OF THE EMBODIMENTS

An exemplary embodiment of the present invention will be described below in detail with reference to the attached drawings.

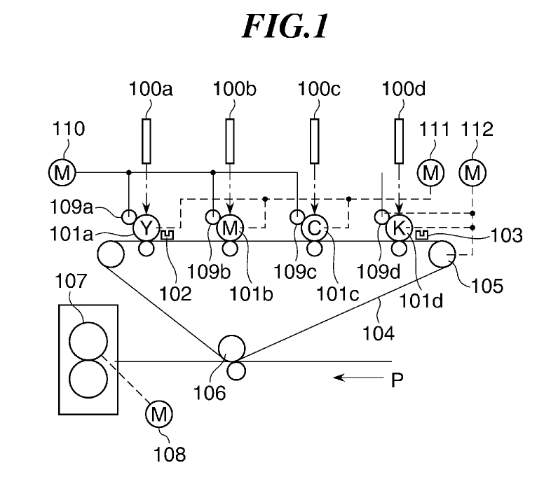

FIG. 1 is a view showing schematically a configuration of an image forming apparatus according to the present exemplary embodiment. FIG. 1 mainly shows a portion where a series of processes from a process of forming an electrostatic latent image to a process of transferring a toner image onto a recording medium is performed. The image forming apparatus is a color image forming apparatus employing a tandem type as an electrophotographic system, and includes image forming units of four colors, which are yellow (hereinafter referred to as “Y”), magenta (hereinafter referred to as “M”), cyan (hereinafter referred to as “C”), and black (hereinafter referred to as “BK”).

Each of the image forming units includes each of photosensitive drums 101a to 101d serving as an image-bearing rotating member. Each symbol “a”, “b”, “c”, and “d” attached to the numerals of 101a to 101d for the photosensitive drums represents that the photosensitive drums 101a to 101d are respectively used for “Y”, “M”, “C”, and “BK”. Therefore, the photosensitive drums 101a to 101c are color photosensitive drums (rotating members), while the photosensitive drum 101d is a monochrome photosensitive drum (rotating member). Symbols “a to d” attached to the numerals of 100a to 100c and 100d for below-described laser scanners, and the numerals of 109a to 109c and 109d for developing devices have the same meanings of the symbol “a to d” attached to the numerals of 101a to 101d.

The photosensitive drums 101a to 101c are driven by a drive motor 111, serving as a rotating member drive unit for the color photosensitive drums, while the photosensitive drum 101d is driven by a drive motor 112, serving as a rotating member drive unit for the monochrome photosensitive drum. The photosensitive drums 101a to 101c are assembled with the same phase in order to cancel an eccentric component of a gear caused during the manufacture of the image forming apparatus, wherein the photosensitive drums 101a to 101c always rotate with the same phase, since they are driven by one drive motor 111. The drive motor 112 drives not only the photosensitive drum 101d, but also a developing device 109d and an intermediate transfer roller 105. Developing devices 109a to 109c are driven by a color-development drive motor 110.

The developing devices 109a to 109d allow toner, which is a developer, to be deposited onto the electrostatic latent image formed on each of the photosensitive drums 101a to 101d, thereby making the electrostatic latent image visible. The electrostatic latent image is formed on each of the photosensitive drums 101a to 101d by an exposure of the laser scanners 100a to 100d based on an image signal. The toner image, which is a visible image, formed on the respective photosensitive drums 101a to 101d are sequentially transferred onto the intermediate transfer belt 104 that is rotated by an intermediate transfer roller 105.

The rotation phase of each of the photosensitive drums 101a to 101c is detected by a phase detection sensor 102.

The toner image formed on the intermediate transfer belt 104 is transferred at a time onto a sheet, which is a recording medium, by a transfer roller 106. The sheet on which the toner image is transferred is conveyed to a fixing unit provided with a fixing roller 107 that is driven to rotate by a fixing drive motor 108, wherein the toner image is fixed onto the sheet using heat by the fixing unit.

In the image forming apparatus according to the present exemplary embodiment, when a print command is received, image signals of the respective colors are fed to the respective laser scanners 100a to 100d, whereby electrostatic latent images are formed on the photosensitive drums 101a to 101d. The formed electrostatic latent images are developed by the developing devices 109a to 109d. The toner images formed from the electrostatic latent images are sequentially transferred onto the intermediate transfer belt 104 that is rotationally driven in a clockwise direction by the intermediate transfer roller 105.

A sheet is conveyed from a sheet feed cassette (not shown) in a direction of an arrow P, whereby the toner images formed on the intermediate transfer belt 104 are transferred at the position of the transfer roller 106. The toner images transferred onto the sheet are fixed onto the sheet using heat from the fixing roller 107, and then, the sheet is discharged to the outside, e.g., discharged onto a sheet discharge tray.

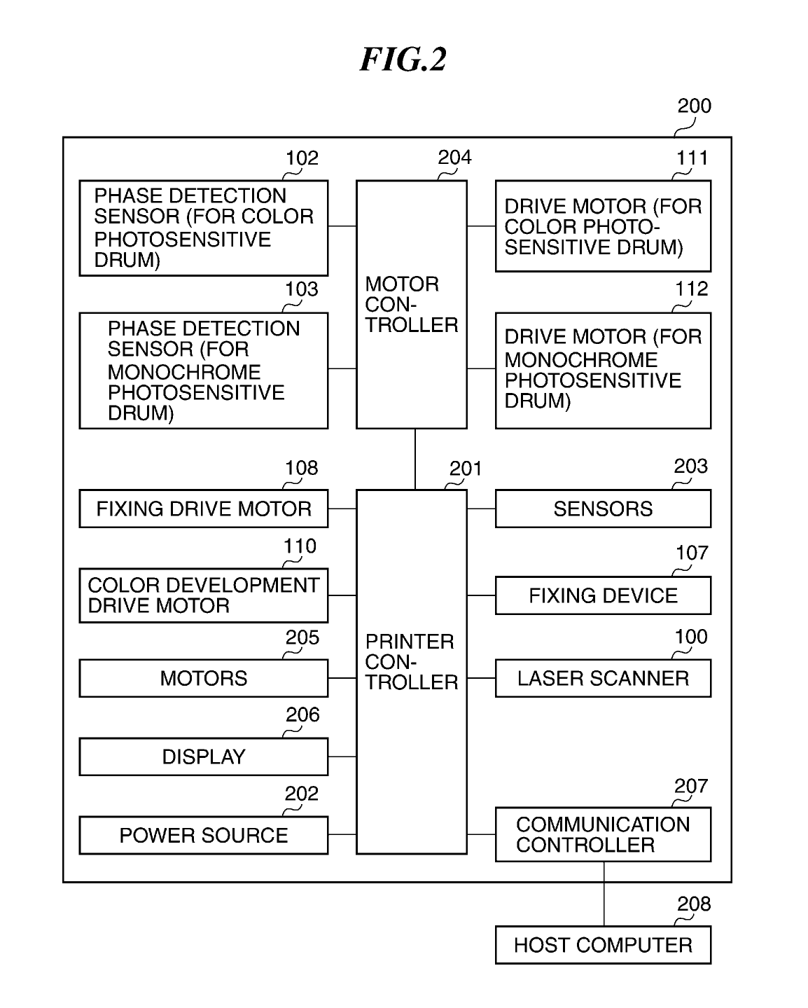

FIG. 2 is a block diagram showing schematically a configuration of a control system of the image forming apparatus. FIG. 2 shows a schematic control system of a printer unit 200 involved with a printing process to a sheet. The respective sections in the printer unit 200 are controlled by a printer controller 201 including operation units such as a Digital Signal Processor (DSP) or Application Specific Integrated Circuit (ASIC), and Central Processing Unit (CPU).

The phase detection sensors 102 and 103 and the drive motors 111 and 112 shown in FIG. 2 have already been described with reference to FIG. 1, so that the description thereof will be omitted. The phase detection sensors 102 and 103, and the drive motors 111 and 112 are controlled by the motor controller 204. The motor controller 204 includes an operation unit such as a DSP or ASIC, and CPU. The operation unit in the motor controller 204 performs a phase changeover control by a rotor position signal from a DC brushless motor (not shown) or a motor start/stop control according to a control signal from a printer controller. The motor controller 204 compares a speed signal from the printer controller 201 and an output from a speed detection unit (not shown), so as to perform a rotation speed control of the drive motors 111 and 112 via a driver.

The fixing drive motor 108 and the color-development drive motor 110 shown in FIG. 2 have already been described with reference to FIG. 1, so that the description thereof will be omitted.

Various electric components and electrically-operated components, which form the image forming apparatus, are operated by power fed from a power source 202. The printer unit 200 includes sensors 203 for detecting conditions of the respective sections in the printer unit 200, in addition to the phase detection sensors 102 and 103. The printer unit 200 also includes various motors 205 (e.g., a drive motor for a roller conveying a sheet) in addition to the drive motors 111 and 112. An operation condition of the image forming apparatus is displayed onto a display 206 in order that a user can confirm the operation condition.

The communication between the image forming apparatus and a host computer 208 is made via a communication controller 207. For example, print data is transmitted from the host computer 208 to the image forming apparatus, while data indicating the printing condition is transmitted to the host computer 208 from the image forming apparatus.

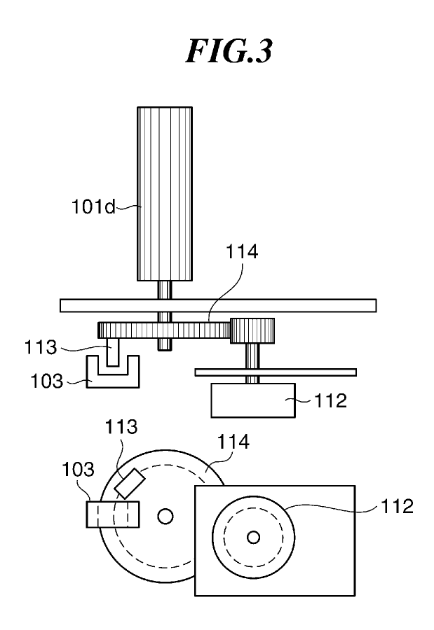

FIG. 3 is a view showing a configuration of a drive system of the photosensitive drum 101d. A gear 114 that rotates together with the photosensitive drum 101d so as to drive the photosensitive drum 101 is mounted to the photosensitive drum 101d. The gear 114 is driven by the drive motor 112. A flag 113 is provided to the gear 114, wherein the flag 113 blocks the optical path of the phase detection sensor 103 during the rotation of the photosensitive drum 101d. By virtue of this configuration, one signal is output every one rotation of the photosensitive drum 101d.

A flag may be provided to the photosensitive drum 101d or a shaft that is integral with the photosensitive drum 101d, and this flag may block light to the phase detection sensor 103. Plural flags, each having a different width, may be provided, wherein plural signals may be output every one rotation of the photosensitive drum 101d.

A drive system of the photosensitive drums 101a to 101c has the same construction as that of the photosensitive drum 101d, except that the single drive motor 111 transmits rotation power to respective gears of three photosensitive drums 101a to 101c.

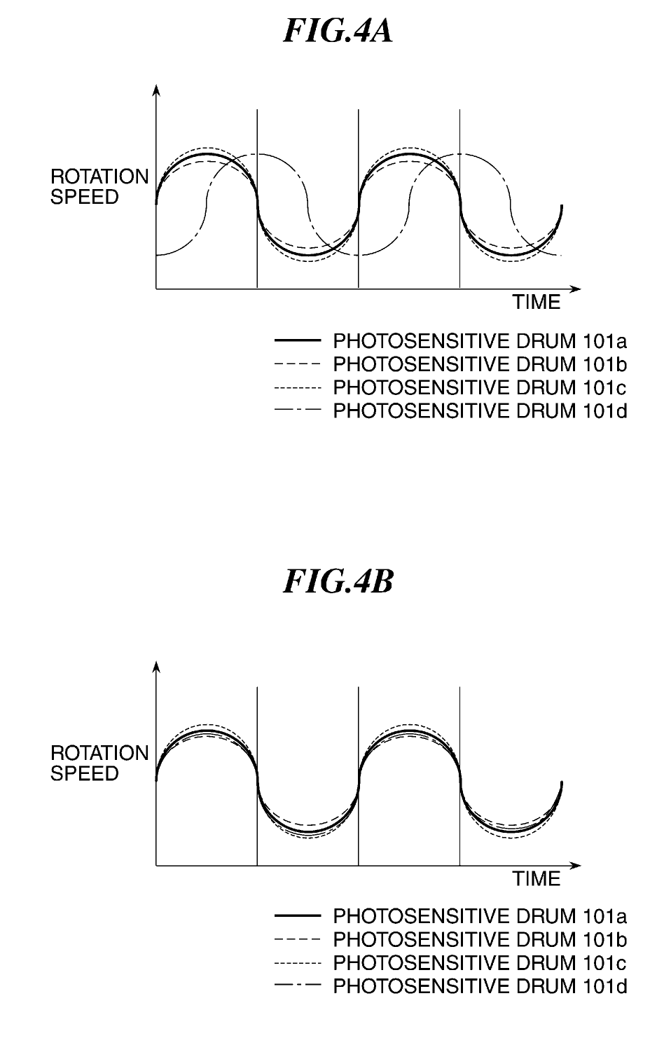

FIGS. 4A and 4B are graphs showing phase synchronization of the rotation speeds of the photosensitive drums 101a to 101d. FIG. 4A shows a state in which the phase of the gear of the drive motor 111, which drives the photosensitive drums 101a to 101c, and the phase of the gear of the drive motor 112, which drives the photosensitive drum 101d, are shifted by 90°. As described above, the photosensitive drums 101a to 101c are assembled with the same phase, and are driven by the single drive motor 111. Therefore, the photosensitive drums 101a to 101c rotate with the same phase.

The rotation phases of the photosensitive drums 101a to 101d are detected by the phase detection sensors 102 and 103 as described above. The motor controller 204 detects phase difference based on the detection result. That is, the motor controller 204 has a function as a phase difference detection unit of the photosensitive drums 101a to 101d.

FIG. 4B shows a state in which the phases of the photosensitive drums 101a to 101c and the phase of the photosensitive drum 101d agree with each other. This state can be realized by controlling the drives of the drive motors 111 and 112 by the motor controller 204 in such a manner that difference between the rotation phase of the photosensitive drum 101a detected by the phase detection sensor 102 and the rotation phase of the photosensitive drum 101d detected by the phase detection sensor 103 becomes zero (specifically, there is no phase difference). Specifically, the motor controller 204 has a function of a phase control unit that controls the drives of the photosensitive drums 101a to 101d based on the detection result of the phase difference. In the present exemplary embodiment, by not generating the phase difference in the rotation phases of the photosensitive drums 101a to 101d, occurrence of the color misregistration can be prevented.

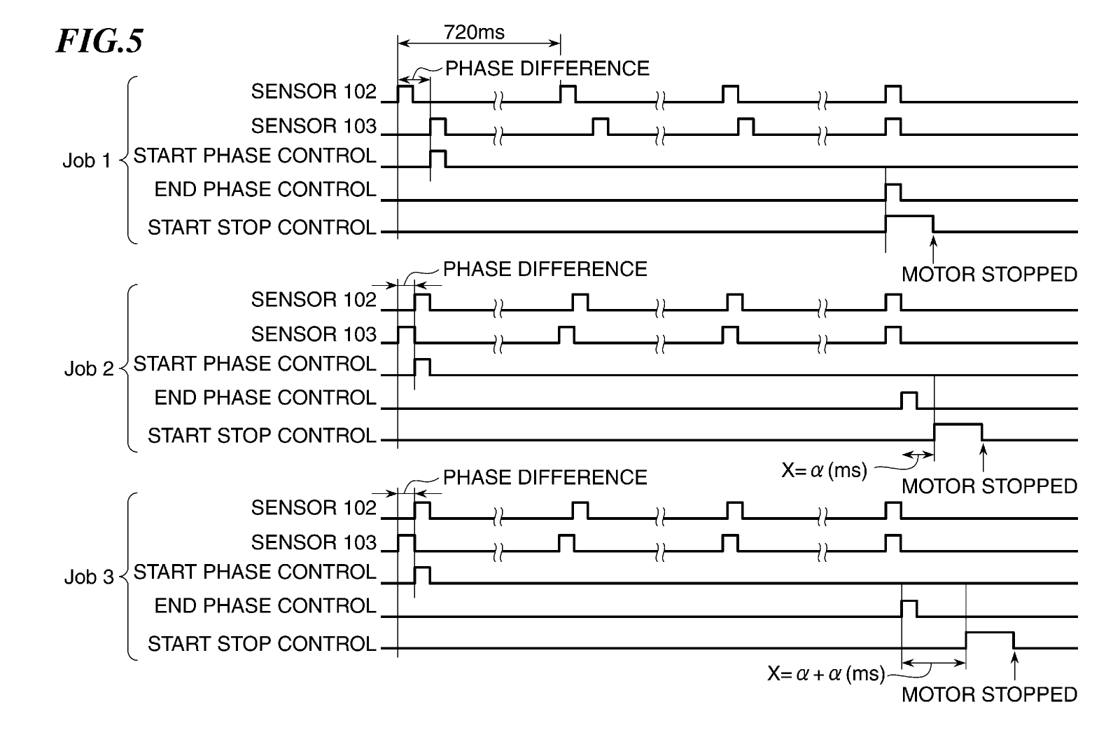

Next, a control method performed in the image forming apparatus will be described. FIG. 5 is a timing chart showing a period from phase control to stop control of the photosensitive drums 101a to 101d. A “Job1” at the upper part in FIG. 5 shows a sensor output timing of the phase detection sensors 102 and 103 and an output timing of a control signal during a period from phase control to stop control of the photosensitive drums 101a to 101d, after certain image formation is completed.

In the present exemplary embodiment, the phase control is performed when the drive motor stops, in order to prevent increase in a first printing time. Accordingly, it is necessary that the phases of the photosensitive drums 101a to 101d are agreed with one another for next image formation, before the drive motors 111 and 112 are stopped. Specifically, the photosensitive drums 101a to 101d are required to be stopped after they have the rotating state shown in FIG. 4B. Therefore, a phase control start signal is output from the motor controller 204 according to the detection of the phase difference of the photosensitive drums 101a to 101d, whereby the drive motor 111 or the drive motor 112 is accelerated or decelerated in order that the phase difference becomes 0°.

In the case of the “Job1”, an output signal from the phase detection sensor 103 is delayed with respect to an output signal from the phase detection sensor 102. Therefore, the motor controller 204 accelerates the drive motor 112, or decelerates the drive motor 111, in order that the phase difference becomes 0° according to the phase control start signal. At a time point when the phases of the photosensitive drums 101a to 101d agree with each other due to the phase control, the motor controller 204 outputs a phase control end signal.

In the case of the “Job1”, a drive stop control signal for stopping the drive motors 111 and 112 is output from the motor controller 204 substantially simultaneously with the output of the phase control end signal. The stop control of the drive motors 111 and 112 is performed on receipt of the drive stop control signal. Thus, the rotations of the photosensitive drums 101a to 101d are also stopped.

A “Job2” at the middle part in FIG. 5 shows a sensor output from the phase detection sensors 102 and 103 and an output timing of the control signal during a period from phase control to stop control of the photosensitive drums 101a to 101d, during image formation carried out subsequent to the control in the “Job1”. Under control of the “Job2”, phase difference of the photosensitive drums 101a to 101d is also detected, like the case of the “Job1”. In the case of the “Job2”, the output signal from the phase detection sensor 103 advances with respect to the output signal from the phase detection sensor 102. Accordingly, the drive motor 112 is decelerated, or the drive motor 111 is accelerated, according to the phase control start signal, in order that the phase difference becomes 0°.

When the phase difference becomes 0°, the phase control end signal is output. When a predetermined time from when the phase control end signal is output to when the drive stop control signal is output is defined as “stop time X”, the stop time X is set to be “0 (ms)” in the previous “Job1”. On the other hand, in the “Job2”, the “stop time X=α (ms)”, which indicates that the output timing of the drive stop control signal is delayed by a shift amount α (ms) from the output timing of the drive stop control signal in the “Job1”.

The shift amount α (ms) is a predetermined value. The drive motors 111 and 112 are stopped according to the drive stop control signal. The motor controller 204 has a function of a stop control unit that changes a time from the completion of the phase control to the stop of the photosensitive drums 101a to 101d, in addition to the function of the phase control unit for the photosensitive drums 101a to 101d.

When the stop time X is shifted by the predetermined time (shift amount α), i.e., when the stop time X is varied, as described above, the positions where the photosensitive drums 101a to 101d are stopped can be shifted. Accordingly, the image forming position in the next image formation can be shifted. Thus, the image deterioration caused by the “drum memory” phenomenon can be suppressed, thereby resulting in that a high-quality color image can be formed.

A “Job3” at the lower part in FIG. 5 shows a sensor output from the phase detection sensors 102 and 103 and an output timing of the control signal during a period from phase control to stop control of the photosensitive drums 101a to 101d, during image formation carried out subsequent to the control in the “Job2”. In the control of the “Job3”, the phase difference of the photosensitive drums 101a to 101d is also detected, like the cases of the “Job1” and the “Job2”. In the case of the “Job3”, the output signal from the phase detection sensor 103 also advances with respect to the output signal from the phase detection sensor 102, like the case of the “Job2”. Accordingly, the drive motor 112 is decelerated, or the drive motor 111 is accelerated, according to the phase control start signal, in order that the phase difference becomes 0°.

When the phase difference becomes 0°, the phase control end signal is output. In the case of the “Job3”, the stop time X is defined as “X=α+α (ms)”. Specifically, in the “Job3”, an output timing of the drive stop control signal is further delayed by the time a (ms) from the output timing of the drive stop control signal in the “Job2”. The drive motors 111 and 112 are stopped according to the drive stop control signal.

As described above, when “Nth” (N: natural number) image forming process is defined as “Job(N)”, and a predetermined time in the “Job(N)”, i.e., a stop time X is defined as “Xa (ms)”, a time X in “Job(N+1)” of “(N+1)th” image forming process is set to be “X=Xa+α (ms)”. The positions where the photosensitive drums 101a to 101d are stopped can be shifted by shifting the stop time X as described above. Accordingly, the image forming position in the next image formation can be shifted.

The stop time X is reset, when exceeding a time (rotation period: 720 ms in FIG. 5) for one rotation of each of the photosensitive drums 101a to 101d. Thus, the period from the output of the phase control end signal to the output of the drive stop control signal can always be set within a rotation period of the photosensitive drums 101a to 101d. The shift amount α (ms) is determined from a drum characteristic (rotation period, and other factors) or control resolution of each of the photosensitive drums 101a to 101d. For example, assuming that the rotation period of each of the photosensitive drums 101a to 101d is 720 ms, by setting the shift amount α to be 10 ms, the positions where the photosensitive drums 101a to 101d are stopped can be shifted by 5 degrees.

In the present exemplary embodiment, the stop time is equally shifted by a (ms) every stop process, until accumulation of the shift amounts reaches a time corresponding to one rotation. However, the process is not limited to that in the present exemplary embodiment, so long as the stop time can be shifted every stop process, e.g., the stop time can be shifted by a different time every stop process.

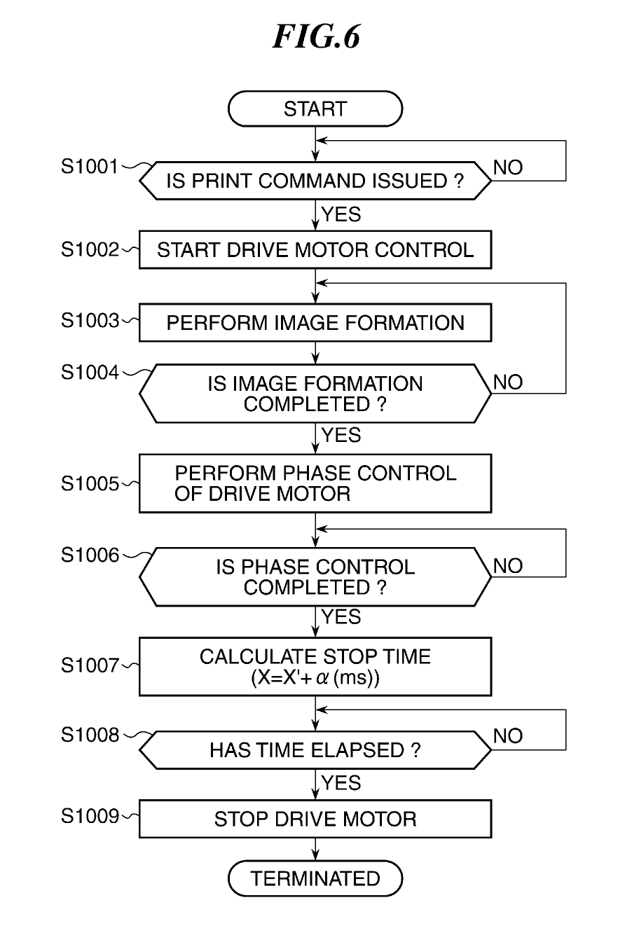

FIG. 6 is a flowchart showing the phase control and the stop control of the photosensitive drums 101a to 101d. The printer controller 201 of the image forming apparatus determines whether a print command is issued from the external host computer 208 or an operation unit (not shown) (step S1001). The image forming apparatus waits until the print command is issued (“NO” in S1001). When receiving the print command (“YES” in S1001), the printer controller 201 starts a drive control for the drive motors 111 and 112 for performing the image formation (step S1002).

After the image forming apparatus is prepared for the image formation, the image forming process including from the formation of the electrostatic latent image to transferring/fixing the toner image onto the sheet and discharging the sheet is performed (step S1003), and then, it is determined whether the image formation is completed (step S1004). The determination in step S1004 becomes “NO” until the image formation is completed. After the completion of the image formation (“YES” in S1004), the phase control of the drive motor 111 that drives the photosensitive drums 101a to 101c and the drive motor 112 that drives the photosensitive drum 101d (step S1005) is performed, and then, it is determined whether the phase control is completed (step S1006).

The determination in step S1006 becomes “NO” until the phase control is completed. After the completion of the phase control (“YES” in S1006), the phases of the photosensitive drums 101a to 101d are controlled to be set to the state shown in FIG. 4B. After the phase control in step S1005 (i.e., the control for causing the gear phases of the photosensitive drums 101a to 101d to agree with one another) is completed (“YES” in S1006), the phase control end signal is issued from the motor controller 204 at the timing shown in FIG. 5. The printer controller 201 calculates the stop time X applied to a current image forming process based on the stop time Xa in a previous image forming process (step S1007). The stop time X applied to the present image forming process is calculated by adding the shift amount α as the adding time to the previous stop time Xa, as described above. Specifically, the equation of X (ms)=Xa+α (Xa: previous stop time, α: shift amount) is established.

When the calculated stop time X exceeds the rotation period (720 ms in FIG. 5) of the photosensitive drums 101a to 101d, the stop time X (ms) is reset. After the stop time X applied to the current image forming process is calculated, it is determined whether the calculated stop time X has elapsed (step S1008). The determination in step S1008 becomes “NO” until the stop time X has elapsed. When the stop time X has elapsed from the output of the phase control end signal (“YES” in S1008), the drive stop control signal is issued, whereby the stop control of the drive motors 111 and 112 is performed (step S1009). Thereafter, the process is terminated.

In the control shown in FIG. 6, the drive control is simultaneously started without performing the phase control, when the drive motor 111 driving the photosensitive drums 101a to 101c and the drive motor 112 driving the photosensitive drum 101d are started, and accordingly, it makes possible to prevent increase in a first printing time. However, in addition to the control described above, the drive motors may be started slowly in order to reduce variations in the rotation speeds of the photosensitive drums 101a to 101d when starting these drums. Moreover, the photosensitive drums 101a to 101d may be stopped slowly, whereby the shift in the phases of the photosensitive drums 101a to 101d can be reduced when the these drums are stopped.

The exemplary embodiment of the present invention has been described above. However, the present invention is not limited to this. For example, the configurations of the photosensitive drums 101a to 101d and the drive motors 111 and 112 driving the photosensitive drums 101a to 101d are only illustrative. The configuration, in which plural drive motors drive plural photosensitive drums, the number of the photosensitive drums is not less than the number of the drive motors, and the rotation phase of each of the photosensitive drums is detected, can perform the drive control same as that in the above exemplary embodiment. Therefore, the same effect can be obtained.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2010-154642 filed Jul. 7, 2010, which is hereby incorporated by reference herein in its entirety.

What is claimed is:

1. An image forming apparatus comprising:
first and second rotating members;
first and second exposure units that form an electrostatic latent image on each of the first and second rotating members;
first and second developing units that develop the electrostatic latent image formed on each of the first and second rotating members;
first and second drive units that drive the respective first and second rotating members; and
a control unit that controls, after the completion of an image formation, the first and second drive units in order that a phase of the first rotating member and a phase of the second rotating member have a predetermined relationship therebetween, and performs a stop process for stopping the first and second drive units,
wherein the control unit varies a period from the completion of controlling the drives of the first and second drive units to the execution of the stop process.

2. The image forming apparatus according to claim 1, further comprising first and second detection units that detect the phases of the first and second rotating members,
wherein, the control unit controls the drives of the first and second drive units such that the difference between the phase of the first rotating member detected by the first detection unit and the phase of the second rotating member detected by the second detection unit becomes zero.

3. The image forming apparatus according to claim 1, wherein the period varied by the control unit is shorter than rotation periods of the first and second rotating members.

4. The image forming apparatus according to claim 1, wherein the control unit changes the period whenever the every stop process is executed.

5. The image forming apparatus according to claim 1, wherein the control unit does not control the drives of the first and second drive units at the time of starting the first and second drive units.
